(19) United States
(12) Patent Application Publication
(10) Pub. No.: US 2008/0106853 A1
(43) Pub. Date: May 8, 2008

(54) Process for Producing Porous Sintered Metal

(76) Inventor: Wataru Suenaga, Ageo-shi (JP)

Correspondence Address: DARBY & DARBY P.C., P.O. BOX 770, Church Street Station, New York, NY, 10008-0770, US

(21) Appl. No.: 11/576,274

(22) PCT Filed: Sep. 28, 2005
(86) PCT No.: PCT/JP05/17898

§ 371 Date: Mar. 29, 2007

(30) Foreign Application Priority Data
Sep. 30, 2004 (JP) 2004-289009

(51) Int. Cl. H01G 9/052; B22F 3/11

(52) U.S. Cl. 361/529; 419/2; 428/546

(57) ABSTRACT

The present invention provides a process for producing a porous sintered metal, in which the pore diameter distribution of porous sintered metal can be easily controlled. The present invention also provides a process including: forming a molding containing a metal powder, a pore forming material, and a binder resin: heating the molding at the decomposition temperature of the pore forming material to thereby effect thermal decomposition thereof: and then sintering the molding at a sintering temperature higher than the decomposition temperature, wherein as the pore forming material, there is used particles of polyhydroxyalkanoate produced in microbial cells. The above molding may be formed by coating or printing onto a base material, a metal powder dispersion containing a metal powder, a pore forming material, a binder resin, and a solvent so as to form a coated material or printed material, and then detaching the base material from the coated material or printed material.

### TECHNICAL FIELD

The present invention relates to a process for producing a porous sintered metal which can be suitably used for a filter member for gas, a separator for cells, a mold for casting non-ferrous metal, a capacitor element and the like.

### BACKGROUND ART

In recent years, technology of components for electronic equipment such as portable telephones, personal computers, and digital cameras has rapidly progressed. During such progress, a porous sintered metal has been used in various fields. For example, a nickel porous plate is used for an anode for a nickel hydrogen battery, and a porous sintered metal is used for a capacitor element, in which the large surface area is utilized. In other fields, for example, a hollow porous metal formed from a flat metal powder is used for a filter member for gas. Moreover, a porous mold is used for a mold for casting such as low pressure casting or die casting.

These porous sintered metals are produced by mixing under agitation, for example, a metal powder or a metal granulated powder granulated using a metal powder and a resin, and a binder resin if required, to form a mixture, then press molding the mixture to obtain a molding, and sintering the molding. Alternatively, such porous sintered metals are produced by kneading a mixture containing a metal powder and a binder resin, to form kneaded matter, and then sintering a molding formed from the kneaded matter.

For example, there is disclosed a process for producing a molding wherein an organic acid ester is added to a metal powder and kneaded, then an alkaline water-soluble phenol resin is added thereto and kneaded, and the mixture obtained in such a manner is formed into a shape of mold, and the molding is sintered in a vacuum or an inert atmosphere (Japanese Unexamined Patent Application, First Publication No. 2000-42688).

Moreover, there is disclosed a process for producing a metal porous plate wherein a nickel fine powder is mixed with a thermoplastic resin such as polyethylene. Then this is formed by extrusion, ultraviolet rays are irradiated thereto so as to produce staple fibers, and then the staple fibers, water, a foam stabilizer, a binder, and a dispersant are mixed, to form in a green tape, which is degreased in a reducing atmosphere, and sintered (Japanese Unexamined Patent Application, First Publication No. 2000-54005).

Furthermore, there is disclosed a production process wherein a paste containing a tantalum fine powder, a binder, and an easy-to-sinter metal is coated onto a base material, and sintered in a vacuum or an inert atmosphere, and then the easy-to-sinter metal is eluted and removed (Japanese Unexamined Patent Application, First Publication No. Hei 02-254108).

In these porous sintered metals, in order to improve characteristics for each application, it is important to increase the porosity in many cases. Since the surface area of the porous body is increased by increasing the porosity, then for example in applications for a nickel porous plate used for an anode for a nickel hydrogen battery, a tantalum anode element for an electrolytic capacitor, and a catalyst, functional parts are increased and the characteristics are improved. Moreover, in a filter or an oil retaining bearing, satisfactory characteristics can be achieved by forming a porous body with a high porosity having a large number of through pores formed therein.

A pore in a porous body is generated in a small gap formed between metal powders, or a gap where a resin as a binder has been eliminated and removed. In order to increase the porosity, it can be considered to decrease the density of the metal powder so as to form a molding for sintering containing a large amount of binder. However, since the shape of the molding is deteriorated in the process for eliminating the binder, it is difficult to obtain a sintered body of a desired structure.

In particular, if the diameter of the metal powder constituting the porous body is reduced in order to increase the surface area of the porous body, adversely pores may be clogged, so that an effective pore volume cannot be maintained. Moreover, the binder may not be completely eliminated, but become a carbon residue which remains in the sintered body.

In order to solve such problems to form a porous sintered metal with a high porosity, fine particles for forming pores are contained in a molding for sintering, so as to form stable pores by eliminating the fine particles. For example, there is disclosed a production process wherein at the time of forming an anode body for a tantalum electrolytic capacitor, a powder obtained by mixing a valve action metal granulated powder of 50 to 200 μm and a solid organic matter having an average particle diameter of 20 μm or less is used as a material, and thereby pores and gaps in the anode body are increased (Japanese Unexamined Patent Application, First Publication No. Hei 11-181505). In this production process, by eliminating the solid organic matter at the time of sintering a molding, pores are formed in the porous sintered metal to facilitate an electrolyte for forming a cathode to permeate therein. Examples of the solid organic matter (pore forming material) include polyvinyl alcohol organic solid matter, acrylic organic solid matter, and camphor.

However, since the elimination and removal of a binder and the solid organic matter by means of heating progress simultaneously, outer walls forming pores are easily damaged, and it is difficult to increase the porosity while keeping the shape of the molding for sintering and the sintered body. In particular, although camphor can be eliminated and removed prior to the binder, it is difficult to reduce the particle diameter, and hence it is not possible to use this method for forming pores having a minute pore diameter of 10 μm or less.

As a result, an attempt has been made to form stable pores by differentiating the elimination temperatures of a pore forming material and a binder, and an investigation is being made into obtaining a porous sintered body through a first step of eliminating the binder by using a pore forming material having a decomposition initiation temperature higher than that of the binder, and a second step of obtaining a sintered body by removing the pore forming material (Japanese Unexamined Patent Application, First Publication No. 2001-271101). However, there is a problem in that the molding from which the binder has been removed, is easily damaged by a large amount of gas generated accompanying decomposition of the pore forming material in the second step.

Furthermore, there is proposed a process wherein resin particles serving as a pore forming material are selectively eluted by a solvent, then the binder is heated and degreased (Japanese Unexamined Patent Application, First Publication No. 2004-43932). However, if the diameter of the resin particles is small, it is difficult for the solvent to permeate into details of the pore. Therefore the elution takes time and it is difficult to completely remove the resin particles.

In this manner, it is not easy to form a stable sintered body having large porosity. In particular, if the diameter of the metal powder is small, it is difficult to produce a sintered body having a sufficient amount of pores, and a superior morphological stability.

As a specific example, in the tantalum porous sintered metal used for the tantalum anode element for an electrolytic capacitor, constant porosity is maintained by forming a tantalum powder mixed with a binder resin in a predetermined mold, and sintering, and then forming pores between secondary particles formed from agglomerated primary particles. In order to further miniaturize the tantalum electrolytic capacitor and to increase the capacity thereof, it is necessary to enlarge the surface area of the porous sintered metal. Therefore, an investigation to reduce the diameter of the tantalum powder constituting the porous sintered metal is being made.

However, if the diameter of the tantalum powder is reduced, not only is fusion caused even at a relatively low temperature so that the pores are prone to be squashed, but also the cohesive power between particles composing secondary particles is weakened, and the secondary particles are prone collapse. Therefore, after the mold is formed, the pores are squashed, making it difficult to form the porous body. Moreover, fine pores formed in gaps between the secondary particles have a greater diameter than that of fine pores formed in gaps between primary particles. Therefore, if the secondary particles are collapsed, there is not enough space formed for the electrolyte for forming a cathode to penetrate into the sintered body. As a result, in the tantalum electrolytic capacitor, if the diameter of the tantalum powder is reduced to increase the pore area so as to increase the capacitance, the extacting rate of the effective capacitance is not increased, and the performance of the capacitor can not be sufficiently improved.

In particular, there is a problem in that if a tantalum powder with a small diameter having a CV value of 10 kCV or more is used, an electrolytic capacitor having a capacitance sufficiently corresponding to the characteristics of the tantalum powder can not be produced.

### DISCLOSURE OF INVENTION

An object of the present invention is to provide a production process enabling to stably produce a porous sintered metal having a high porosity, in particular a production process enabling to stably produce a porous sintered metal having a high porosity achieved by a distribution of a large number of pores of a small volume.

In particular, an object of the present invention is to provide a process for producing a porous sintered metal for an anode element for an electrolytic capacitor enabling to produce a porous sintered metal having a high porosity even if a valve action metal having primary particles of a small diameter is used for increasing the capacity, and which enables surface treatment to be readily performed since an electrolyte can readily permeate therein.

A process for producing a porous sintered metal of the present invention comprises: forming a molding containing a metal powder, a pore forming material, and a binder resin; heating the molding at the decomposition temperature of the pore forming material to thereby effect thermal decomposition of the pore forming material; and then sintering the molding at a sintering temperature higher than the decomposition temperature, wherein the pore forming material is particles of polyhydroxyalkanoate produced in microbial cells.

In the process for producing a porous sintered metal of the present invention, the molding may be formed by coating or printing onto a base material, a metal powder dispersion containing a metal powder, a pore forming material, a binder resin, and a solvent, and then detaching the base material from the coated material or printed material. By going through such a coating or printing process, a thin molding can be formed and a sheet-like porous sintered metal can be readily produced.

In the process for producing a porous sintered metal of the present invention, the metal powder may be a valve action metal. In this case, if the CV value is 100 kCV or more, the effect of the present invention is remarkable, and hence this is preferable.

Moreover, in the process for producing a porous sintered metal of the present invention, the valve action metal may be made of tantalum. Furthermore, in the process for producing a porous sintered metal of the present invention, the molding may be sintered after being provided with a lead.

The porous sintered metal of the present invention is produced by the process for producing a porous sintered metal.

Furthermore, the anode element for an electrolytic capacitor of the present invention is formed from a porous sintered metal produced by the process for producing a porous sintered metal.

According to the process for producing a porous sintered metal of the present invention, since fine particles of polyhydroxyalkanoate produced in microbial cells are used as a pore forming material, a large number of pores having uniform shape and size with a small pore diameter can be formed. Moreover, since the fine particles have a low and constant decomposition initiation temperature, almost all pore forming material is quickly decomposed prior to the binder resin. As a result, in each of the processes for forming a porous sintered metal such as degreasing and sintering, the molding and the sintered body are not damaged, and there is no remaining carbon left in the sintered body, so that a sintered body having a high porosity can be stably and readily produced.

In particular, when the production process is used for producing an anode element for an electrolytic capacitor, pores can be stably formed in the anode element, facilitating an electrolyte for forming a cathode to permeate therein. As a result, even if a valve action metal powder having a small particle diameter is used, pores can be formed, and the large capacitance inherent in a valve action metal powder having a small particle diameter can be realized, and the performance of the electrolytic capacitor can be improved.

### BRIEF DESCRIPTION OF THE DRAWINGS

FIG. 1 shows an example of thermal decomposition curves of a binder resin and polyhydroxyalkanoate produced in microbial cells.

FIG. 2 is a perspective view describing a process for producing a porous sintered metal of the present invention.

FIG. 3 is a schematic diagram showing an example of an electrolytic capacitor.

FIG. 4 is a graph showing a pore diameter distribution of a porous sintered metal in example 1.

FIG. 5 is a graph showing a pore diameter distribution of a porous sintered metal in example 2.

FIG. 6 is a graph showing a pore diameter distribution of a porous sintered metal in comparative example 1.

FIG. 7 is a graph showing the pore diameter distributions of the porous sintered metals in example 1, example 2, and comparative example 1, superposed on the same horizontal axis.

The reference numerals shown in these figures are defined as follows: 11a and 11b, molding; 12, lead wire; and 13, assembly.

### BEST MODE FOR CARRYING OUT THE INVENTION

### First Embodiment

A first embodiment of a process for producing a porous sintered metal of the present invention is described. The production method of the first embodiment is a so-called dry method, in which firstly a mixture containing a metal powder, a pore forming material, and a binder resin is filled into a mold, so as to form a molding by means of press molding or the like. Subsequently, the molding is heated at the decomposition temperature of the pore forming material to thereby effect thermal decomposition of the pore forming material. Then the molding is sintered at a sintering temperature higher than the decomposition temperature, so as to form a porous sintered metal.

The metal material constituting the metal powder is not particularly limited and examples include at least one type of Fe, Ni, Co, Cr, Mn, Zn, Pt, Au, Ag, Cu, Pd, Al, W, Ti, V, Mo, Nb, Zr, and Ta, or an alloy containing at least one type thereof. Preferably the metal powder has a purity of 99.5% or more, and is an agglomerate powder having a volume average particle diameter of 1 to 100 μm in order to form a stable porous body. Among the metal powder, from the point of suitability as a capacitor element, it is preferably made of a valve action metal and has a CV value of 100 kCV or more. Examples of the valve action metal include tantalum, aluminum, niobium, and titanium. Among these valve action metals, tantalum and niobium are suitable, and furthermore tantalum is particularly preferred.

Moreover, the diameter of the primary particles is preferably 0.01 to 5.0 μm, and more preferably 0.01 to 1.0 μm, since a high capacity can he achieved when used as a capacitor element.

The metal powder may be an agglomerate powder formed from an agglomerate of primary particles, or may be a metal granulated powder formed by granulation using a resin. In the case of a metal granulated powder, it can be directly mixed with a pore forming material and then press molded, to form a molding.

The pore forming material of the present invention is particles of polyhydroxyalkanoate produced in microbial cells. Although the polyhydroxyalkanoate of the present invention is chemically synthesized, it is difficult to perform polymerization of a high molecular weight product with stereoregularity, and the method is already falling behind compared to a method using microbes, for which industrial production studies have commenced. Moreover, even if polyhydroxyalkanoate is synthesized by a chemical method, it is expected to be difficult to particulate more evenly.

The polyhydroxyalkanoate of the present invention is a condensation polymer of 3-hydroxyalkanoate represented by the following formula (1), wherein R is an alkyl group represented by CₙH₂ₙ₊₁, and preferably n=1 to 15.

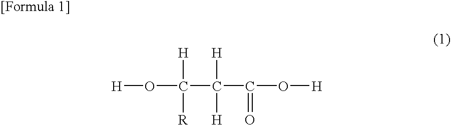

Specific examples of 3-hydroxyalkanoate include 3-hydroxybutyrate of n=1, 3-hydroxyvalerate of n=2, 3-hydroxyhexanoate of n=3, 3-hydroxyheptanoate of n=4, 3-hydroxyoctanoate of n=5, 3-hydroxynonanoate of n=6, 3-hydroxydecanoate of n=7, 3-hydroxyundecanoate of n=8, and 3-hydroxydodecanoate of n=9, and the polyhydroxyalkanoate may be a homopolymer or copolymer thereof.

Among these polyhydroxyalkanoates, preferred is a copolymer (PHBH) of 3-hydroxybutyrate of n=1 and 3-hydroxyhexanoate of n=3.

Examples of the microbe which produces polyhydroxyalkanoate include bacteria of the genus Alcaligenes such as A. lipolytica, A. eutrophus, A. latus, the genus Pseudomonas, the genus Bacillus, the genus Azotobacter, the genus Nocardia, and the genus Aeromonas. Among them, particularly preferred are strains such A. caviae, and also Alcaligenes eutrophus AC32 into which a gene of PHA synthetase group is introduced (FERM P-15786) (J. Bacteriol., 179, p 4821-4830 (1997)).

By culturing these microbes under an appropriate condition, microbial cells having polyhydroxyalkanoate accumulated therein can be obtained. By treating the microbial cells and separating by means of a centrifugal method or the like, the polyhydroxyalkanoate can be taken out from the tissue of the microbe.

Moreover, in such a production using microbes, normally, only one of the optical isomers is selectively produced. Therefore the chemical or physical properties are highly uniform and the product is homogeneous in terms of chemical structure. As a result, there is provided a characteristic in that the distribution of decomposition temperature is narrow and the total amount is quickly decomposed within a fixed range of temperature. Furthermore, the hardness is high and deformation hardly occurs in the process of forming a molding.

Moreover, the polyhydroxyalkanoate produced using these microbes can be suitably used particularly in a wet method, since it is chemically stable against various organic solvents, and is hardly dissolved or swollen when mixed with a metal powder, a binder, and an organic solvent to form a slurry, and thus there is almost no limitation on the solvent for producing a porous sintered body by means of the wet method.

The polyhydroxyalkanoate produced using these microbes is controlled by the shape and size of the individual microbes, and thus has characteristics of a small particle diameter and a uniform size distribution. Therefore, the shape and size of the polyhydroxyalkanoate can be adjusted by selecting the genus or species of microbe, and can be also controlled by the culture condition under which the microbe produces the polyhydroxyalkanoate.

In this manner, the diameter of pores formed in a porous sintered metal can be controlled by the particle diameter of polyhydroxyalkanoate. Moreover, the number of pores can be controlled by the dosage thereof. As a result, by selecting the particle diameter and the dosage of polyhydroxyalkanoate, there can be provided a satisfactory mechanical strength by matching the type of metal powder to be used or the diameter of the primary particles thereof, and there can be realized a size, number, and distribution of pores suitable for each application. If a porous sintered metal is used for an electrolytic capacitor, the particle diameter of polyhydroxyalkanoate is particularly preferably 1 to 10 μm, since more appropriate pores can be formed and the reduction in the capacity can be further suppressed to keep a high capacity, so that an electrolyte for forming a cathode can even more readily permeate therein. The dosage thereof is preferably 1 to 50%, and more preferably 5 to 30% in the volume ratio with respect to the metal powder, in order to form effective pores without decreasing the mechanical strength of the metal sintered body.

Moreover, in order to take out the polyhydroxyalkanoate produced in microbial cells as fine particles, there is used a method in which microbes containing polyhydroxyalkanoate are treated with a protease, a surfactant, or a functional water so as to solubilize cell substances other than the polyhydroxyalkanoate, and then the fine particles of polyhydroxyalkanoate are taken out (Japanese Unexamined Patent Application, First Publication No. Sho 60-145097, and Japanese Unexamined Patent Application, First Publication No. 2000-166585).

A publicly known binder resin can be used as the binder resin. Examples of suitable binder resins include polyvinyl alcohol, polyvinyl acetal, a butylal resin, a phenol resin, an acrylic resin, a urea resin, a polyurethane, a polyvinyl acetate, an epoxy resin, a melamine resin, an alkyd resin, a nitrocellulose resin, and a natural resin. These resins may be solely used, or a plurality of types thereof may be used in combination.

Among them, an acrylic resin is preferred. Since an acrylic resin is almost completely decomposed and does not remain as carbon, after the binder is decomposed and eliminated in a vacuum, the leakage current can be kept low in an electrolytic capacitor using an acrylic resin.

The glass transition point of a binder resin is preferably 50° C. or less, and more preferably room temperature or less. If the glass transition point of the binder resin is 50° C. or less, the molding can be flexible. Therefore damage occurring in the process up to the completion of sintering can be reduced.

The content of the binder resin in the raw material mixture is preferably within a range of 0.01 to 30 parts by weight, and more preferably 0.01 to 15 parts by weight, per 100 parts by weight of metal powder.

As a method of forming a molding containing a metal powder, a binder resin, and a pore forming material by the dry method without using a paint coating technique, publicly known methods can be widely used. For example, there can be used a method of mixing under agitation, a pore forming material and a metal powder granulated using a resin to make a mixture, and filling the mixture into a mold to effect press molding.

Moreover, a molding can be also formed by dissolving a binder resin in a solvent with a metal powder, and spraying onto the surface of the metal powder, and then mixing under agitation the pore forming material and the metal powder coated with the binder resin, and press molding in a mold.

In order to produce a porous sintered metal for an anode element for an electrolytic capacitor by the dry method, a valve action metal powder, a binder resin, and a pore forming material made of polyhydroxyalkanoate is mixed and filled in a mold Next, a tantalum wire serving as a lead wire, is planted in the mixture which is then dried for example at about 60° C. for about 60 to 120 minutes, and heat treatment is performed at about 300 to 600° C. in a vacuum, so as to eliminate the pore forming material and the binder resin in the molding. Furthermore, a high temperature heat treatment (sintering) is performed for about 10 to 30 minutes at about 1200 to 1600° C., to fuse the metal powders to each other, and the metal powder to the lead wire. By so doing, there can be obtained a porous sintered metal integrated with the lead wire for forming an anode element for an electrolytic capacitor.

### Second Embodiment

A second embodiment of the process for producing a porous sintered metal of the present invention is described.

The production method of the second embodiment is a wet method in which firstly a metal powder, a pore forming material, a binder resin, and a solvent are mixed and dispersed, so as to prepare preferably a paint-like metal powder dispersion. The metal powder dispersion is coated or printed on a base material to form a coated material or printed material. Then the base material is detached from the coated material or printed material, to form a molding. The step for forming a porous sintered metal from the molding is the same as that of the fist embodiment. In the production method of the second embodiment, for the metal powder, and the pore forming material, those from the first embodiment can be used, and for the binder resin, those from the first embodiment which are soluble in a solvent can be used, and thus the description thereof is omitted.

Examples of the solvent constituting the metal powder dispersion include water, alcohols such as methanol, IPA (isopropyl alcohol), and diethyleneglycol, cellosolves such as methyl cellosolve, ketones such as acetone, methyl ethyl ketone, and isophorone, amides such as N,N-dimethylformamide, esters such as ethyl acetate, ethers such as dioxane, a chlorinated solvent such as methyl chloride, and aromatic hydrocarbons such as toluene and xylene, which can be solely used or a plurality of types thereof may be used in combination. Among them, for a better control of the pore diameter, preferred are solvents which do not dissolve polyhydroxyalkanoate. Examples of such solvents which do not dissolve polyhydroxyalkanoate include water, alcohols such as methanol, IPA (isopropyl alcohol), and diethyleneglycol, cellosolves such as methyl cellosolve, ketones such as acetone, methyl ethyl ketone, and isophorone, amides such as N,N-dimethylformamide, esters such as ethyl acetate, ethers such as dioxane, a chlorinated solvent such as methyl chloride, and aromatic hydrocarbons such as toluene and xylene, which can be solely used or a plurality of types thereof may be used in combination.

The content of the solvent in the metal powder dispersion is set to an extent which allows a smooth implementation of coating or printing of the metal powder dispersion on the surface of an appropriate base material.

Moreover, the metal powder dispersion can be appropriately mixed with various additives in addition to the metal powder, the binder resin, and the solvent, in order to provide the metal powder dispersion with suitable physical properties to be coated or printed on the surface of an appropriate base material, and to stably maintain the dispersion of the metal powder. Example of suitable additives include a dispersant such as phthalic acid ester, phosphoric acid ester, and fatty acid ester, a plasticizer such as glycol, alcohol of a low boiling point, an antifoaming agent of silicone type or non silicone type, and a dispersant such as a silane coupling agent, a titanium coupling agent, and quaternary ammonium salt.

The blending ratio of respective components in the metal powder dispersion is for example such that the binder resin is 0.01 to 30 parts by weight and preferably 0.01 to 15 parts by weight, the solvent is 5 to 160 parts by weight, and the additive is 5 parts or less by weight, with respect to 100 parts by weight of the metal powder.

The viscosity of the metal powder dispersion is about 0.1 to 1000 Pa·s and preferably 0.1 to 100 Pa·s, from the point of its coating property and handling property.

In the preparation of the metal powder dispersion, the metal powder, the pore forming material, the binder resin, the solvent, and the additive may be dispersed all at the same time using various grinding/dispersing equipment, or they may be sequentially mixed and dispersed.

Example of the grinding/dispersing equipment include a roll type kneader such as a twin or triple-roll type, a vertical kneader, a pressure kneader, a wing type kneader such as a planetary mixer, a disperser such as a bal grind mill, a sand mill, and an attritor, an ultrasonic disperser, and a nanomizer.

Next, this metal powder dispersion is coated or printed on the base material, which is then dried to evaporate the solvent in the metal powder dispersion, so as to form a thin sheet (molding) comprising the metal powder and the binder resin on the base material (the solvent may remain).

Here, as to the base material, there can be used a glass or a synthetic resin sheet which is stable against the metal powder dispersion, in particular the solvent, and preferably a polyethylene terephthalate film (PET film) provided with a release layer made of a polyvinyl alcohol resin or the like.

The release layer may be formed by coating a paint for a release layer on the base material. By forming the release layer on the base material, a coating film formed from the metal powder dispersion located on the release layer can be directly detached from the base material with ease, and moreover, the release layer remaining on the coating film can function as a protective layer which prevents damage of the coating film formed from a metal dispersion thereafter.

As the resin used for such a release layer, there is preferably used a resin which is compatible with the binder resin in the metal powder dispersion, in order to improve the adhesion of the release layer and the layer formed from the metal powder dispersion, and to facilitate the detachment from the boundary between the release layer and the base material. Examples of such a resin for a release layer include polyvinyl alcohol, polyvinyl acetal, a butyl resin, and an acrylic resin.

The thickness of the release layer is preferably within a range of 1 to 20 μm, and is particularly preferably within a range of 1 to 10 μm, since carbon remaining on the coating film after sintering the release layer can be reduced, and the strength of the coating film can be appropriately maintained by the release layer.

Examples of the coating methods of the metal powder dispersion include air doctor coating, blade coating, rod coating, extrusion coating, air knife coating, squeeze coating, impregnation coating, reverse roll coating, transfer roll coating, gravure coating, kiss coating, cast coating, and spray coating.

Examples of the printing methods of the metal powder dispersion include stencil printing, intaglio printing, and lithographic printing. Among them, stencil printing is preferred since the molding for sintering can be formed in various desired shapes, such as a hexahedron, a cylinder, and a comb tooth shape.

The thickness of the sheet (molding) obtained by coating or printing can be appropriately set, and the thickness (thickness of wet material) of the coated material (printed material) before being dried may be for example within a range of several μm to 300 μm. Moreover, the obtained sheet (molding) may be cut in a desired shape by slitting or piercing before or after being detached from the base material, as required.

In such a wet method, the porous sintered metal can be readily made thinner compared to the dry method.

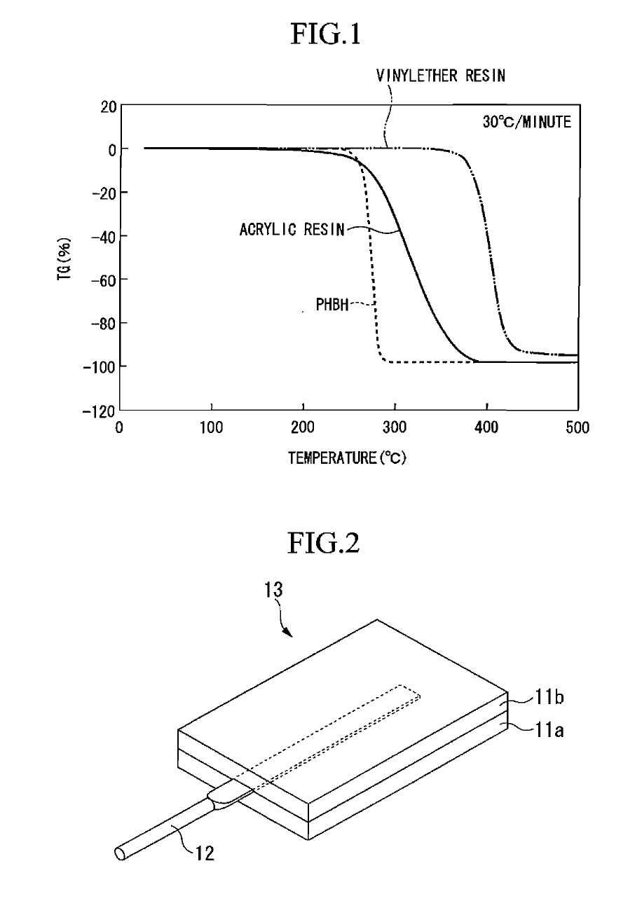

In the process for producing the porous sintered metal in the first and second embodiments described above, particles of polyhydroxyalkanoate produced in microbial cells are used as the pore forming material. Since polyhydroxyalkanoate produced in microbial cells has a homogeneous chemical structure, in the heat decomposition curve (refer to FIG. 1), the difference between the decomposition initiation temperature and the decomposition completion temperature is small (that is, quickly decomposed), and the decomposition completion temperature is lower than that of the binder resin. Accordingly, in the heat treatment step, firstly the pore forming material is eliminated to form pores, and then the binder resin is eliminated. By eliminating the pore forming material and the binder resin in this order, sintering can be performed while the structure is fixed, desired pores can be readily formed in the porous sintered metal, and the pore diameter distribution of the porous sintered metal can be readily controlled. For example, pores having a larger diameter than that of fine pores formed in gaps between primary particles of the metal powder, can be formed in the porous sintered metal.

The porous sintered metal obtained by the above production method of the first and second embodiments is used in the production of an electrolytic capacitor as an anode element for an electrolytic capacitor. Hereunder is a description of a method of producing an anode element for an electrolytic capacitor using the porous sintered metal.

In order to produce an anode element for an electrolytic capacitor by the dry method, when forming a molding for sintering by filling into a mold, a mixture comprising a pore forming material and granules formed by mixing a liquid binder resin and a valve action metal powder, a lead wire made of the valve action metal is fixed to the molding by either setting the lead wire in the mold and then filling the mixture therein, or filling the mixture and then planting the lead wire in the mixture, and thereafter the lead wire and the valve action metal are fused by sintering the molding.

Moreover, in the wet method, as shown in FIG. 2, a lead 12 is placed on a sheet-like molding 11a obtained by the wet method, and another sheet-like molding 11b is flintier superposed thereon. Then, an appropriate pressure treatment is applied as required, so as to stick two sheet-like moldings 11a and 11b and the lead 12 together to form an assembly 13. Alternatively, the assembly 13 may be formed by folding one wide sheet in half, and holding the lead 12 therebetween to laminate.

Next, the assembly 13 is dried for example at about 60° C. for about 60 to 120 minutes, and a heat treatment is performed at about 300 to 600° C. in a vacuum, so as to eliminate the pore forming material and the binder resin in the moldings 11a and 11b. Furthermore, a high temperature heat treatment (sintering) is performed for about 10 to 30 minutes at about 1200 to 1600° C., to fuse the valve action metal powders to each other, and the valve action metal powder to the lead. By so doing, there can be obtained an anode element for an electrolytic capacitor having the lead 12 provided between the moldings 11a and 11b, which are all integrated.

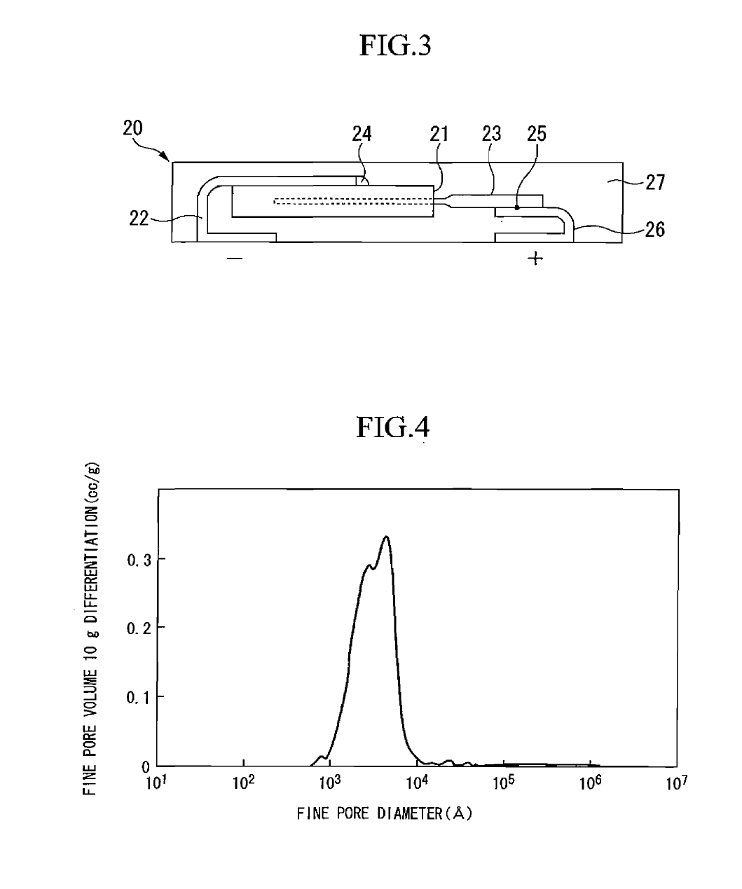

In order to obtain an electrolytic capacitor using the above anode element for an electrolytic capacitor, firstly a porous sintered metal is placed into an electrolyte bath, after which a predetermined DC voltage is applied so as to effect a conversion treatment, to thereby form an oxide layer on the surface of the porous sintered metal. Next, a cathode forming electrolyte, being a solution of manganese dioxide or that of a functional polymer, is made to permeate therein, so as to form a solid electrolyte having a manganese dioxide layer or a functional polymer layer coated on the oxide layer. Subsequently, on the anode element for a capacitor formed with the oxide layer/manganese dioxide layer or functional polymer layer, is formed a carbon (graphite) layer and a silver paste layer, to effect a treatment for a cathode. Moreover, as shown in FIG. 3, one end of a cathode terminal 22 is joined onto the surface of an anode element 21 for a capacitor by a conductive adhesive 24, and a tip portion 25 of a lead 23 is joined to an anode terminal 26 by means of spot welding. Thereafter, a resin exterior 27 is formed for example by resin molding, or by soaking in a resin solution, so that an electrolytic capacitor 20 can be obtained.

Similarly to the above production of an electrolytic capacitor, by using a sintered body for an electrolytic capacitor anode element which uses a porous sintered metal produced by the abovementioned production method, even if a valve action metal powder having a small particle diameter which can realize a high capacitance is used, a sintered body with a high porosity can be formed. Therefore the electrolyte for forming a cathode can readily permeate therein.

The present invention is not limited to the abovementioned embodiments. In the above embodiments, a lead is provided in the moldings, however a lead is not necessarily provided. A porous sintered metal without a lead may be used as a material for forming a metal component.

### EXAMPLES

Hereunder is a description of the process for producing a porous sintered metal of the present invention, with reference to examples.

### Example 1

50 g of tantalum powder S-15 (manufactured by Cabot Supermetals K.K.) having an average primary particle diameter of 0.1 μm and a capacitance of 150 kCV/g, 0.5 g of PHBH resin beads (manufactured by Kanegafuchi Kagaku K.K., 1% by weight with respect to tantalum powder) having an average primary particle diameter of 1 μm as a pore forming material, 7.5 g (solid content; 3 g) of acrylic resin “NCB-166” (manufactured by Dainippon Ink and Chemicals, Inc., glass transition point; −10° C.) as a binder resin, 4.8 g of cyclohexanone (solvent), and 300 g of zirconia having a diameter of 3 mm, were placed in a plastic bottle, and mixed and dispersed using a shaker (paint conditioner), so as to obtain a tantalum powder dispersion.

On the other hand, a solution of an acrylic resin “IB-30” (manufactured by Fujikurakasei Co., Ltd.) was coated on a PET film having a thickness of 50 μm by a #16 wire bar, to provide a release layer having a thickness of 4 μm.

Next, the metal powder dispersion was coated on the release layer of the PET film by an applicator having a predetermined depth, and then this was dried at about 60° C. for about 60 to 120 minutes, so as to obtain a dry coating film of the metal powder dispersion having a thickness of 200 μm.

A sheet (molding) of the dry paint coating sheet (molding) was detached from the base material, and on this sheet was superposed another sheet of of dry coating film sheet, which was then subjected to a pressure treatment to stick two sheets together, so as to form a molding having a dimension of 10 mm×20 mm. In order to make a measurement sample for accurately measuring the fine pore distribution of the sintered body, the lead wire was not held between the sheets.

Next, the molding obtained in this manner was heat treated in a vacuum at about 400° C. for 4 hours, to eliminate organic matters (binder resin and PHBH resin beads). Furthermore, a high temperature heat treatment (sintering) was performed for about 20 minutes at about 1200° C. The vacuum attainment level at this time was 2.67×10⁻⁷ Pa. In this manner, by fusing the tantalum powders, a sheet-like tantalum porous sintered body was obtained.

0.292 g of the obtained tantalum porous sintered body was placed in a sample cell of a porosimeter (PoreSizer 9320 manufactured by Shimadzu Corporation.), and the fine pore distribution was measured by a mercury press-in method. The calculation was performed assuming that, at this time, the cell constant was 10.79 μl/pF, the contact angle was 130 degrees, the surface tension was 484 dyne/cm, and the specific gravity of mercury was 13.5462.

At this time, the total fine pore volume was 0.179 ml/g, the mode diameter was 0.41 μm, the loading weight density was 3.19, and the percentage of void was 57.0% The fine pore distribution diagram is shown in FIG. 4.

### Example 2

The making tantalum dispersion was performed in the same manner as that of example 1, except that the blending quantity of the PHBH resin beads (manufactured by Kanegafuchi Kagaku K.K.) having an average primary particle diameter of 1 μm was 1.0 g (2% by weight with respect to tantalum powder). Then, a molding was formed and sintering was performed so as to obtain a sheet-like tantalum porous sintered body. 0.495 g of the obtained tantalum porous sintered body was placed in a sample cell of the porosimeter, and the fine pore distribution was measured by the mercury press-in method.

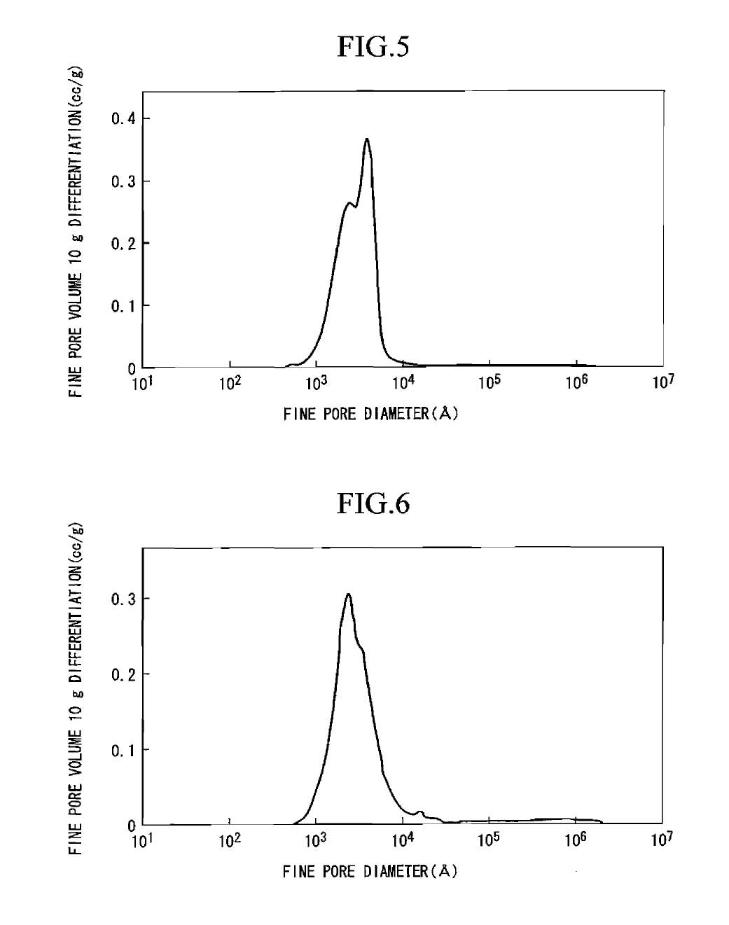

At this time, the total fine pore volume was 0.166 ml/g, the mode diameter was 0.37 μm, the loading weight density was 3.41, and the percentage of void was 56.6%. The fine pore distribution diagram is shown in FIG. 5.

### Comparative Example 1

The painting was performed in the same manner as that of example 1, except that the PHBH resin beads (manufactured by Kanebuchi Kagaku K.K.) having an average primary particle diameter of 1 μm were not mixed. Then, a molding was formed and sintering was performed so as to obtain a sheet-like tantalum porous sintered body. 0.265 g of the obtained tantalum porous sintered body was placed in a sample cell of the porosimeter, and the fine pore distribution was measured by the mercury press-in method.

At this time, the total fine pore volume was 0.165 ml/g, the mode diameter was 0.24 μm, the loading weight density was 3.32, and the percentage of void was 54.9%. The fine pore distribution diagram is shown in FIG. 6.

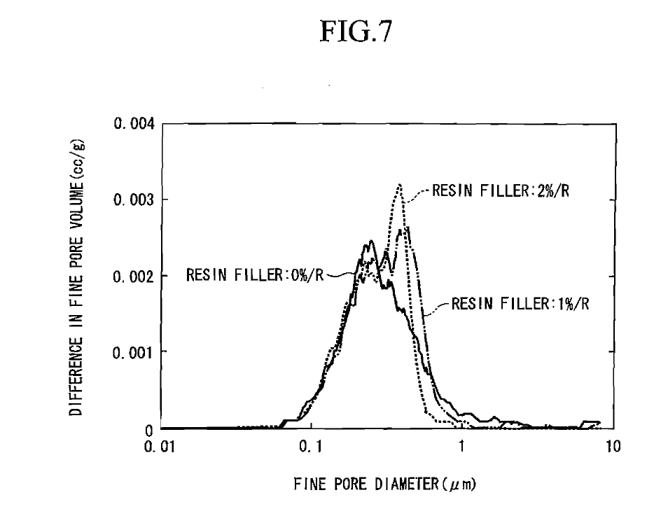

As is apparent from FIG. 4 to FIG. 6, in example 1 and example 2, it is understood that, in addition to pores having a peak of the same pore diameter as that of the comparative example 1, different pores having a sharp peak in a position of a larger pore diameter tan that of these pores are formed. In order to further clarity the change of pore distribution, FIG. 7 shows these pore distributions of the tantalum porous sintered bodies formed in example 1, example 2, and comparative example 1 superposed on the same horizontal axis. That is, the pore distribution shifts in a direction of larger pore volume, and the mode diameter is enlarged. Since the specific gravity of tantalum was high and the dosage of PHBH was not high, the loading weight and the total fine pore volume were not so different. However, the effect of PHBH addition is apparent. Therefore, by adjusting the particle diameter and the dosage of polyhydroxyalkanoate, the fine pore distribution in a porous sintered metal can be controlled. The reason why the peak position is smaller than 1 μm is considered to be because the fine pores might be slightly squashed by the weight of the tantalum involved in the fusion at the time of sintering.

In this manner, when the process for producing a porous sintered body of the present invention is applied to the manufacture of a porous sintered body for a tantalum electrolytic capacitor, even if a tantalum powder having a CV value of 10 kCV or more is used, sufficient pores can be formed in the sintered body, and therefore the electrolyte can permeate into the sintered body deeply inside. Accordingly, a small electrolytic capacitor having a high capacitance can be produced.

### INDUSTRIAL APPLICABILITY

According to the production process of the present invention, in each of the processes for forming a porous sintered metal such as degreasing and sintering, the molding and the sintered body are not damaged, and there is no remaining carbon left in the sintered body, so that a sintered body having a high porosity can be stably and readily produced. Therefore the process can be suitably used for producing a porous sintered metal such as a filter member for gas, a separator for cells, a mold for casting non-ferrous metal, and a capacitor element. In particular, when used for producing an anode element for an electrolytic capacitor, even if a valve action metal powder having a small particle diameter is used, pores can be formed, and the large capacitance inherent in a valve action metal powder having a small particle diameter can be realized, and the performance of the electrolytic capacitor can be improved

1. A process for producing a porous sintered metal comprising:
forming a molding by coating or printing onto a base material, a metal power dispersion containing a metal powder, a pore forming material, and a binder resin, and a solvent so as to form a coated material or printed material, and thereafter detaching said base material from said coated material or printed material;
heating said molding at a decomposition temperature of said pore forming material to thereby effect thermal decomposition of said pore forming material, and thereafter
sintering said molding at a sintering temperature higher than said decomposition temperature,
wherein said pore forming material is particles of polyhydroxyalkanoate produced in microbial cells.

2. (canceled)

3. The process for producing a porous sintered metal according to claim 1, wherein said polyhydroxyalkanoate is a condensation polymer of a compound represented by the following formula (1): 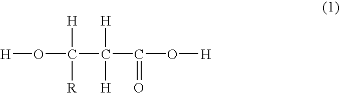
(wherein R is an alkyl group represented by CₙH₂ₙ₊₁ (n is an integer of 1 to 15) or a hydrogen atom).

4. The process for producing a porous sintered metal according to claim 3, wherein said polyhydroxyalkanoate is a copolymer of 3-hydroxybutyrate of n=1 and 3-hydroxyhexanoate of n=3 in a compound represented by said formula (1).

5. The process for producing a porous sintered metal according to claim 1, wherein said metal powder is made of a valve action metal and has a CV value of 100 kCV or more.

6. The process for producing a porous sintered metal according to claim 5, wherein said valve action metal is made of tantalum.

7. The process for producing a porous sintered metal according to claim 5, further comprising providing said molding with a lead wire, and thereafter the sintering.

8. A porous sintered metal produced by the process for producing a porous sintered metal according to claim 1.

9. An anode element for an electrolytic capacitor formed from a porous sintered metal produced by the process for producing a porous sintered metal according to claim 5.
